(19) United States
(12) Patent Application Publication
(10) Pub. No.: US 2010/0020649 A1
(43) Pub. Date: Jan. 28, 2010

(54) DEVICE FOR DISPLAYING TIME

(76) Inventor: Andreas KURTZE, Fritzens (AT)

Correspondence Address: WENDEROTH, LIND & PONACK, L.L.P., 1030 15th Street, N.W.,, Suite 400 East, Washington, DC, 20005-1503, US

(21) Appl. No.: 12/504,031

(22) Filed: Jul. 16, 2009

(30) Foreign Application Priority Data
Jul. 22, 2008 (EP) 08013132.9

(51) Int. Cl. G04C 17/00; A44C 17/02; A44C 17/00

(52) U.S. Cl. 368/241; 63/28; 63/31; 63/32

(57) ABSTRACT

A device for displaying time, in particular a wrist watch, comprising a plurality of gemstones and a plurality of illumination elements which are arranged on or at a carrier and via which the gemstones can be selectively illuminated or have light shone through them in order to display the time, wherein each gemstone being respectively held in its own mount protruding from the carrier.

The invention relates to a device for displaying time, in particular a wrist watch, comprising a plurality of gemstones and a plurality of illumination elements which are arranged on a carrier and via which the gemstones can be selectively illuminated and/or have light shone through them in order to display the time.

Ever since the start of the production of watches, it has been conventional to make the manufactured watches as elegant as possible, so that, in addition to their capacity to display the time of day, the watches can also serve as an item of jewelry. For this reason, analog wrist watches have, in particular, also been provided with gemstones.

With the introduction of compact electronic components and small illumination sources, for example in the form of light emitting diodes (LEDs), it became possible to produce time display means in which—in an electronically controlled manner—the illumination sources serve to display the time in that they are arranged at the side of gemstones that is remote from the viewer and then shine light through the gemstones. Owing to the visual properties of gemstones, in particular of precious stones, this produces particularly elegant and luxurious-looking devices for displaying time.

DE 10 2004 058 245 and WO 2006/136587 both disclose wrist watches in which, at the surface of the wrist watch, gemstones are incorporated into the wrist watch, light emitting diodes being arranged under some of these gemstones in order to display the time. In both of these documents, the fact that the gemstones are integrated, for example by adhesive bonding, directly into the outer side of the wrist watch is found to be disadvantageous. On the one hand, this makes the incorporation of the gemstones costly and places stringent requirements on the manufacturing precision of the outer face of the watch. On the other hand, the connection of the gemstones to the wrist watch is insufficiently stable or sufficiently secure connection of the gemstones to the wrist watch is possible only with great technical effort.

The object of the invention is to avoid the foregoing drawbacks and to provide a device for displaying time in which gemstones and illumination elements of this type can easily be mounted and a secure connection between the time display means and the gemstones is possible using simple means.

This is achieved by a device for displaying time having the features of claim 1.

That is to say, the fact that each gemstone is held by its own mount, which in turn protrudes from the carrier, allows the device for displaying time easily to be fitted with the gemstones, in particular because the mounts protrude from the surface of the carrier. The surface of the carrier can in this case be part of the outer face of the watch or else be arranged below the outer face, which faces the viewer. In addition, because the gemstones each have their own mount, the connection between the gemstone and the device for displaying time is particularly simple to produce, although the connection obtained as a result can still be carried out in an extremely stable manner.

Also provided in the device according to the invention for displaying time is a controller which activates the illumination elements, the illumination elements selectively illuminating the gemstones and, additionally or alternatively, shining light through the gemstones. In this case, it is possible to display the time with the aid of a plurality of gemstones of this type, which are illuminated and/or have light shone through them, for example in that the respectively active illumination elements present the time in alphanumeric characters or else an analog hour and minute hand and also if appropriate a second hand are imitated by the active illumination elements. A combination of both and also, in addition, a date display and further features known per se in watches are also possible. For powering the device according to the invention for displaying time, use is also made of known means such as for example accumulators or batteries. In this case, these accumulators can be rechargeable batteries, capacitors, inductively chargeable accumulators or the like.

Further advantageous embodiments of the invention are defined in the dependent claims and will be described in greater detail hereinafter.

In a particularly preferred embodiment of the invention, the mounts are substantially cylindrical, the gemstones being held in an end of the mounts that is remote from the viewer, i.e. by or at the edge of these mounts. The mounts can in this case be embodied in a sleeve-shaped manner or else as solid bodies having defined light paths. As symmetrical gemstones are preferably used, cylindrical mounts are particularly advantageous owing to their rotational symmetry.

In this case, there are in principle various possibilities as to how the gemstones are held by the mounts. Thus, one embodiment of the invention provides for the edge of a mount of this type to be raised and the gemstones to be held by this raised edge. However, it may also be advantageous, additionally or alternatively, to use an adhesive in order to connect the gemstones to the mounts. The adhesive may be in the form of conventional adhesives used for connections between gemstones and metal.

It is particularly preferred if the gemstones are held by the mounts on that side of the mount that faces the viewer when he checks the time, i.e. for example at the outer side of a wrist watch. The other end of the mount can in this case be connected directly to the carrier. In this case, provision may be made for the mounts to be adhesively bonded to the carrier. However, other connecting means and connecting technologies, which are known per se in the art, are also possible for the connection between the carrier and the mounts. A further embodiment of the invention provides for the mounts and the carrier to be formed in one piece, for example in that the carrier comprising the mounts is punched out of a metal layer or stamped into a metal layer.

In particular for the use of the device according to the invention for displaying time as a wrist watch, the basic parts should be made small and compact. For this reason, it is particularly preferable to provide light emitting diodes for the illumination elements. Light emitting diodes of this type are distinguished by the fact that they take up little space, by their low generation of heat, their low energy requirements and also their long durability. In addition, the brightness and color of the light irradiated by the light emitting diodes are easy to regulate and control.

One embodiment of the invention provides for the illumination elements, which are preferably embodied as light emitting diodes, to be arranged in a plurality of the mounts. This allows the gemstones to be directly illuminated by illumination elements arranged below them (i.e. in the direction of the carrier) and little light to be lost as a result of lateral irradiation. Provision may also be made to make the inner surfaces of the mounts particularly reflective, for example by way of a coating, so that little light is absorbed even by the mounts themselves. However, it is also possible to arrange illumination elements next to the mounts and in this case to design the mounts in such a way that light from the illumination elements enters the mounts and subsequently illuminates or shines through the gemstones. Additionally or alternatively, provision may also be made to arrange the illumination elements below the end of the mounts that is remote from the viewer, for example below the carrier, and in this case to design the carrier in such a way that light from these illumination elements can pass into the mounts and reach the gemstones.

Especially for the presentation of alphanumeric characters by the illumination elements, provision is made for a large number of illumination elements and gemstones of this type to be used for a device according to the invention for displaying time. For this reason, it is advantageous to use gemstones which can be manufactured economically but are still elegant. Particularly suitable for this purpose are artificial or natural glass stones, which appear particularly elegant if they have surfaces which are cut, preferably in a faceted manner. It is however also possible to use other natural or synthetic semiprecious stones or precious stones, although this involves significantly increased material costs. The gemstones may in principle be of any desired shape, configuration and size, depending on the nature and size of the device for displaying time.

In particular when used as a wrist watch, it is disadvantageous, for a device according to the invention for displaying time, to arrange the illumination elements in one plane, as this further reduces the space available for the illumination elements and gemstones. For this reason, one embodiment of the invention provides for the carrier, on which the mounts protruding therefrom are arranged, to form a, preferably convexly, curved surface, at least in certain portions. This allows the carrier to cling tight to the user's arm. However, provision may also be made for the carrier to be not entirely rigid, but to have at least a certain stability. It should be noted in this regard that this, preferably convex, curvature can relate only to the basic parts of the surface of the carrier, as a carrier of this type also requires in all cases devices for fastening, for example, the watch strap or the housing of the watch, which devices can obstruct such curvature.

Furthermore, provision is made for a longitudinal axis of the mounts to be locally arranged substantially perpendicularly to the carrier or the surface of the carrier and therefore also for the tips or the panes of the gemstones to define an envelope having a, preferably convex, curvature. A longitudinal axis of this type is, for example in the case of cylindrical mounts, that axis of the cylinder that defines the axis of symmetry with respect to rotation. In the case of other rotationally symmetrical mounts, the term may also be taken to refer to the axis of symmetry.

A particularly preferred embodiment of the invention provides for the gemstones to be arranged, at least in certain portions, in rows and columns, thus producing an elegant outer side, facing the viewer, of the device for displaying time. Depending on the number of gemstones and illumination elements used, they can particularly effectively produce an alphanumeric presentation of the time display. The same applies to the imitation of an analog hour hand and minute hand or second hand. It is of course also possible to provide for the display to alternate or be able to switch over between these two types of representation. In this case, provision may be made for there to be implemented in the device for displaying time a controller which, on the one hand, can selectively activate the illumination elements and, on the other hand, can switch between various types of presentation and also if appropriate control the brightness and color of the irradiated light.

In order to allow a particularly uniform image of the outer face of the time display means according to the invention, provision may be made for the distances between two adjacent mounts, i.e. the intermediate space between two adjacent mounts, to correspond substantially to the diameter of a mount. This may be an average diameter, should not all the mounts be embodied in the same way or the mounts be non-symmetrical. The intermediate space between adjacent mounts is in this case envisaged as that space between two mounts along the line connecting their center points.

A further embodiment of the invention provides for the mounts and the gemstones held thereby to be designed as a separate component. As a result, the mounts and the gemstones can be arranged particularly economically and simply in the device for displaying time.

The invention relates further to a method for manufacturing a device for displaying time as discussed above, the gemstones being fastened to the mounts and these mounts comprising the gemstones subsequently being mounted to the carrier. In this case, provision may be made for the mounts comprising the gemstones to be individually mounted to the carrier or else for the gemstones first to be mounted to the mounts and the mounts subsequently to be jointly mounted to the carrier.

Further details and advantages of the present invention will be described hereinafter in greater detail based on the description of the figures given with reference to the drawings, in which:

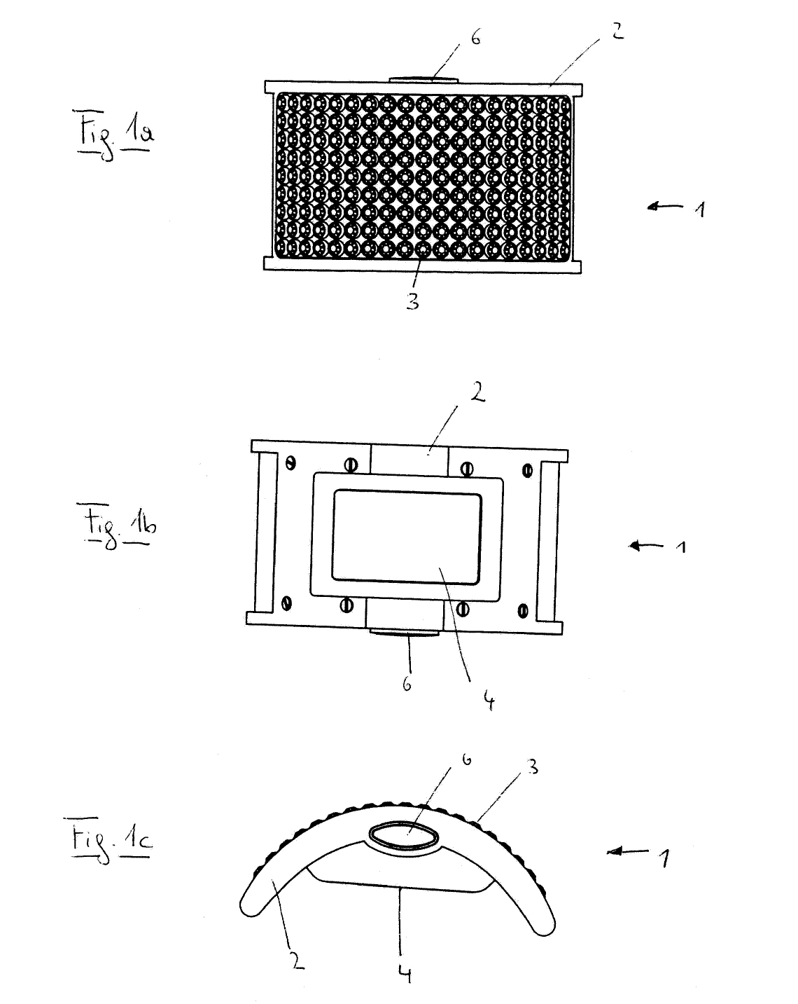

FIGS. 1a to 1c are a plan view of the upper side and the underside and also a side view of an embodiment of the device according to the invention for displaying time;

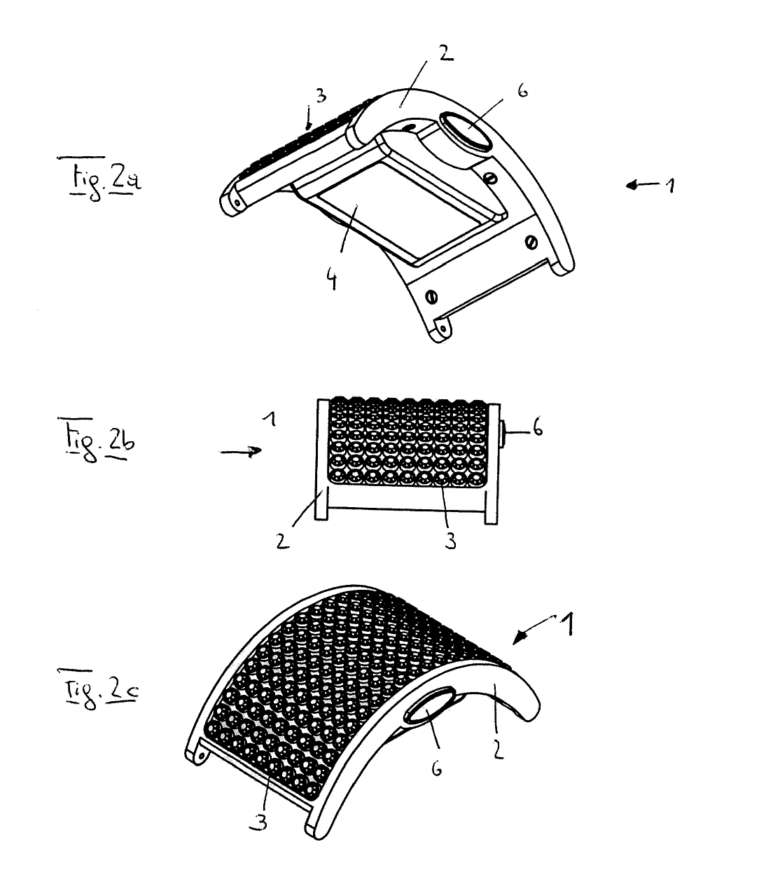

FIG. 2a to 2c are a further side view and also two perspective views of this embodiment of the device according to the invention;

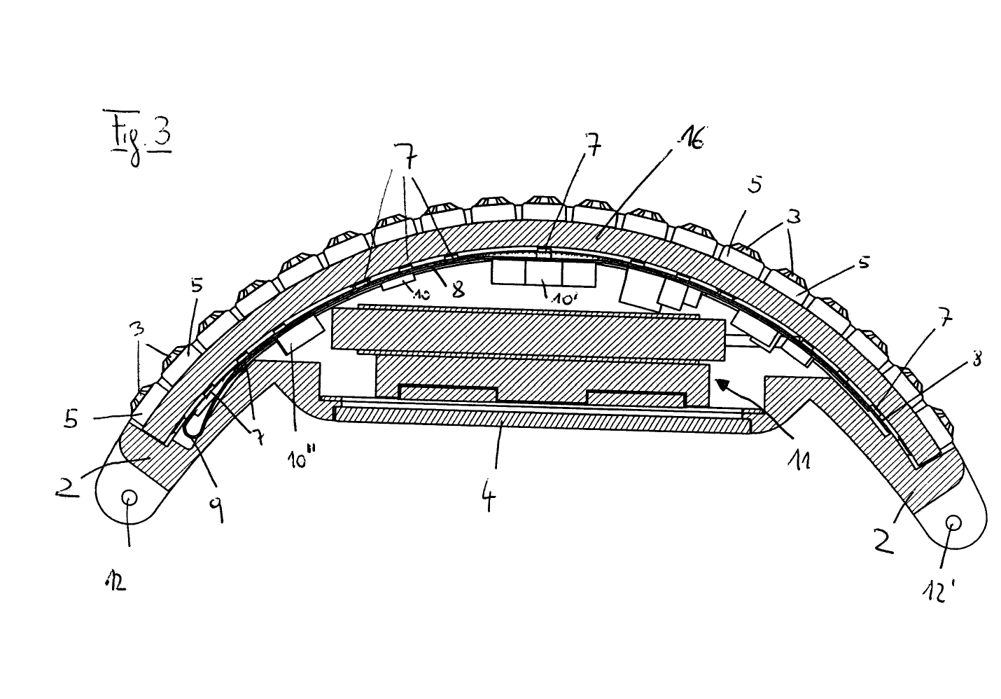

FIG. 3 is a sectional illustration of this embodiment of the device according to the invention;

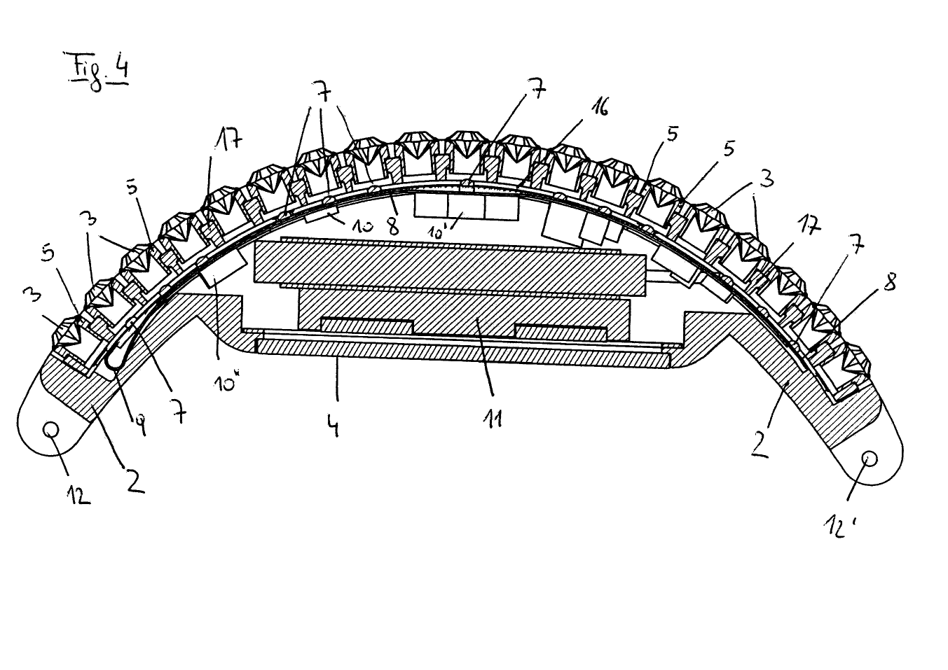

FIG. 4 is a further sectional illustration of the embodiment of the device according to the invention,

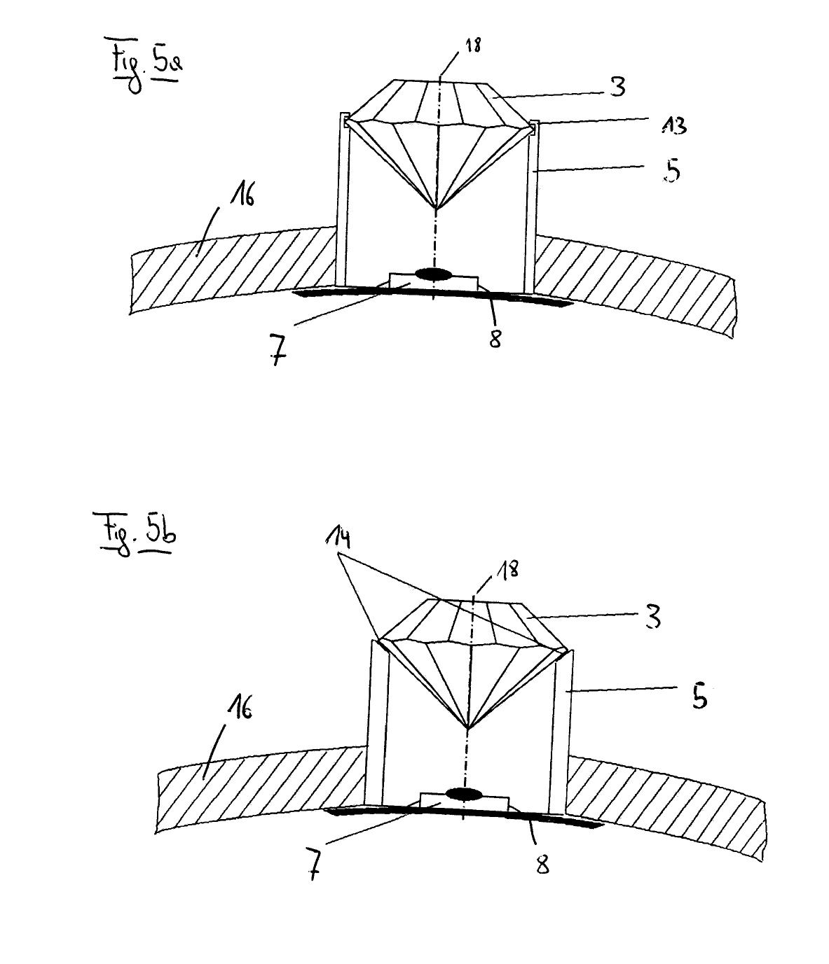

FIGS. 5a and 5b show two different embodiments of the connection between gemstones and mounts;

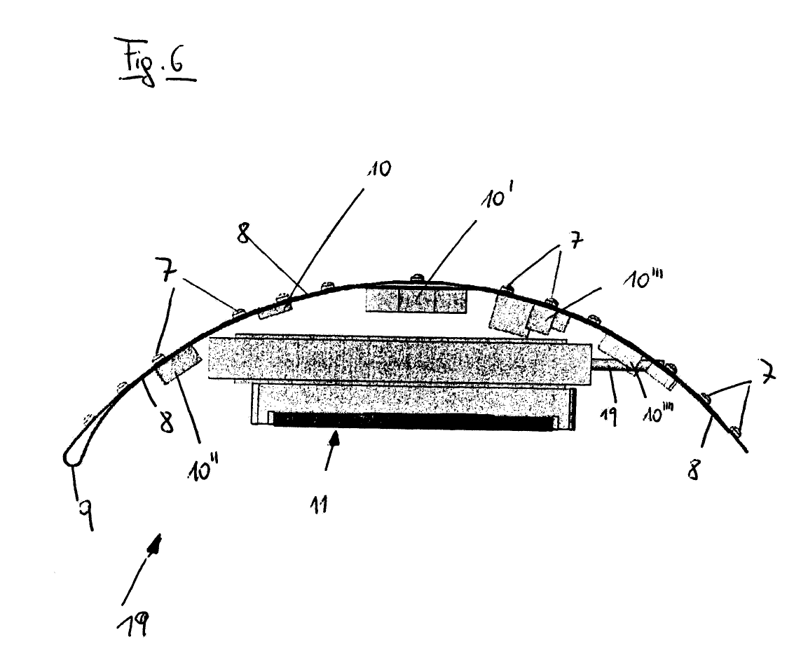

FIG. 6 is a schematic illustration of a controller of the arrangement of the illumination elements with associated control elements; and

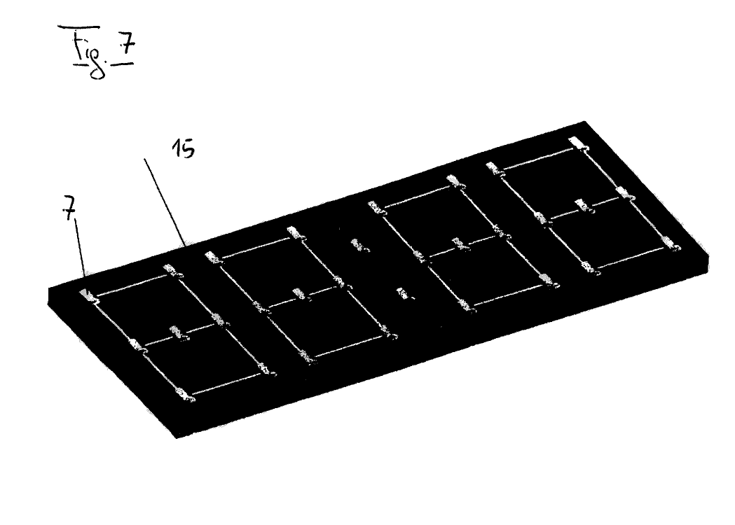

FIG. 7 is a schematic illustration of the implementation of a time display by means of illumination elements.

FIGS. 1a to 1c show an embodiment, embodied as a wrist watch 1, of the device according to the invention for displaying time; for the sake of clarity, the watch strap itself is not shown. FIG. 1a is a plan view onto the upper side of the wrist watch. In this case, a large number of gemstones 3 are arranged, in regular rows and columns, on the housing 2 of the watch. In this case, illumination elements in the form of light emitting diodes 7 are arranged under a plurality of these gemstones 3 in order to display the time. In this case, provision is made for light from these light emitting diodes 7 to pass through those gemstones 3 which are arranged above the light emitting diodes 7. As a result, it is possible to present the time, for example by means of alphanumeric characters. Various setting possibilities can be carried out by means of an adjustment knob 6 or the mode of presentation of the time display can be alternated or else the date can be displayed by actuating this adjustment knob 6, at least for a certain period of time. FIG. 1b is a plan view of the underside of the wrist watch 1. In this case, provision may be made for the bottom 4 of the housing 2 of the watch to be transparent, at least in certain regions, thus allowing the internal electronics of the wrist watch 1 to be inspected. Finally, FIG. 1c is a side view of the wrist watch 1, showing, again, the adjustment knob 6 and the gemstones 3 protruding beyond the surface of the housing 2 of the watch.

FIG. 2a and 2c are a perspective view, once from above and once from below, of the wrist watch 1 according to the invention. As may be seen, the gemstones 3, which are arranged in rows and columns, each have at their outer side a pane defining overall an envelope face having convex curvature. This allows the wrist watch 1 to cling to the arm of a person wearing this wrist watch 1. Furthermore, provision may be made for the housing 2 of the watch to be flexible, at least to a certain extent. Owing to this aforementioned curvature, it is advantageous for the surface of the carrier 16, on which the mounts 5 of the gemstones 3 are arranged, itself to be curved convexly. Owing to the large number of gemstones 3 arranged, it may also be made possible for a plurality of features to be presented simultaneously, for example a time and date display, on the wrist watch 1.

FIG. 3 is a sectional illustration along the circumferential direction of the wrist watch 1 between two columns of gemstones 3. The housing 2 of the watch itself is fastened to the watch strap by means of two devices 12 and 12′. Arranged above the bottom 4 of the watch is a control unit 11 which serves, not only to control the light emitting diodes 7, but also to receive the power supply means, i.e. for example an accumulator or one or more batteries. A clock generator which is responsible for the time signal, for example a quartz crystal, can also be accommodated here. A large number of cylindrical mounts 5, which project beyond the surface of the carrier 16, i.e. protrude from the carrier 16 and hold the gemstones 3 at the side opposite the carrier 16, are arranged on the carrier 16. In this case, each gemstone 3 is held by its own mount 5. In order to simplify the illustration, not every one of the in this case similar gemstones 3 and mounts 5 is provided with a reference numeral. The same applies to the light emitting diodes 7 and further controllers 10.

Light emitting diodes 7 are arranged at the underside of the carrier under some of the gemstones 3, wherein the light irradiated by the light emitting diodes can pass through the gemstones 3 arranged above them and as a result display the time. Further controllers 10, 10′, 10″ are, again, arranged under some of the light emitting diodes 7, wherein a printed circuit board 8 can be arranged therebetween. The further controllers serve to control the time display, by selectively activating the light emitting diodes 7, and also if appropriate to control the brightness or color of the light irradiated by the light emitting diodes 7.

For electrically connecting the light emitting diodes 7, a printed circuit board 8 is arranged between the controllers 10, 10′, 10″ and the light emitting diodes 7. In this case, the light emitting diodes 7 are fastened, for example by soldering-on, directly on the printed circuit board 8. In order to adapt to the convex curvature of the surface of the carrier 16, this printed circuit board 8 is itself curved. In a region 9 of the printed circuit board 8, the printed circuit board is folded, thus facilitating the electrical connection to the controllers 10, 10′, 10″. As a result of such curvature or folding of the printed circuit board 8, particularly compact installation of the necessary electrical connection of the light emitting diodes 7 is possible and even gemstones 3 positioned right at the edge of the wrist watch 1 can be shone through and/or illuminated by way of light emitting diodes 7 of this type.

FIG. 4 is a further sectional view of the wrist watch 1, the sectional line being parallel to but laterally offset from that in FIG. 3. This sectional view is taken through a column of gemstones 3, so that the interior of the mounts 5 is shown. In addition to those features which may also be seen in FIG. 3, it is apparent here that the cylindrical mounts 5 are embodied so as to be internally hollow, i.e. in a sleeve-shaped manner. The light emitted by the light emitting diodes 7 arranged under some of the gemstones 3 strikes the gemstones 3 directly and shines through them in the process. Furthermore, it may be seen that the mounts 5 are held on the carrier 16 by connecting elements 17. In this case, provision may be made for the mounts 5 to be clamped to the carrier 16 by means of these connecting elements 17 or else for other conventional types of metal connections to be used. The inner surface of the cylindrical mounts 5 can be coated with a reflective layer, so that a particularly high proportion of the light emitted by the light emitting diodes 7 passes through the particular gemstone 3. It may also be seen that the longitudinal axis 18 of the cylindrical mounts 5 is in each case locally positioned perpendicularly to the curved surface of the carrier 16.

FIG. 5a shows how, in an advantageous embodiment of the invention, a gemstone 3, which is in this case cut in a faceted manner, is held by its own cylindrical mount 5. In the case illustrated here, a light emitting diode 7, which is connected to the curved printed circuit board 8, is arranged under this gemstone 3. The cylindrical mount 5 protrudes in this case from the carrier 16, the protruding end of the mount 5 having a raised edge 13 by means of which the gemstone 3 is held by the mount 5. The longitudinal axis 18 of the cylindrical mount 5 is positioned substantially perpendicularly to the surface of the carrier 16.

FIG. 5b shows a further embodiment of the invention. In this case, the gemstone 3 is adhesively bonded to the mount 5 by means of an adhesive layer 14 and is as a result held by the mount 5. In this case, use is made of conventional types of adhesive used for producing a connection between the metal and gemstone.

FIG. 6 is a schematic illustration of the controller 19 as a whole of the wrist watch 1 and the light emitting diodes 7 serving to display the time. The controller 19 comprises a curved printed circuit board 8 which has a folded region 9 and which serves to electrically connect the light emitting diodes 7 fastened on the curved printed circuit board 8. Various controllers 10, 10′, 10″, 10′″, 10′″, which are connected to a further control unit 11, which is also an element of the control unit 19, via the connecting element 19, are arranged below the curved printed circuit board 8, which may be flexible in order to produce the fold 9. The controllers 10, 10′, 10″, 10′″, 10′″ are also attached directly to the printed circuit board 8.

Owing to this flexibility, the printed circuit board 8 can be fitted when flat with the light emitting diodes 7 and the controllers 10, 10′, 10″, 10′″, 10′″ in order not to assume the curved and/or folded shape until it is mounted.

The controllers 10, 10′, 10″, 10′″, 10′″ and also the controller 11 display the time in that in each case some of the light emitting diodes 7 are selectively activated in order to irradiate light. In addition to the power supply, the means for clocking the time, i.e. for example a quartz crystal, are also arranged in the control unit 11. In addition, it is thus possible to control a date display, as well as the color and brightness of the light irradiated by the light emitting diodes 7. Further features known per se, which are possible in digital watches, may also be implemented.

FIG. 7 shows the principle of displaying the time by means of light emitting diodes 7. In the example illustrated here, a plurality of light emitting diodes 7 are arranged on a printed circuit board 15 which is in this case embodied so as to be flat. The total number of light emitting diodes 7 arranged serves to provide an alphanumeric time display, individual diodes of the light emitting diodes 7 in each case emitting light and presenting in the process the particular time.

It goes without saying that the device according to the invention for displaying time neither is limited to the exemplary embodiments illustrated in the figures or in the description, nor is to be restricted thereby.

In this case, the invention can both include just one type of gemstones with regard to shape and/or material and a plurality of different types of gemstones, and be constructed homogeneously or heterogeneously. Nor is it necessary for all the gemstones to be arranged in the same way in the mounts, although this is preferred.

1. A device for displaying time, in particular a wrist watch, comprising a plurality of gemstones and a plurality of illumination elements which are arranged on or at a carrier and via which the gemstones can be selectively illuminated or have light shone through them in order to display the time, wherein each gemstone is respectively held in its own mount protruding from the carrier.

2. The device as claimed in claim 1, wherein the mounts are embodied substantially cylindrically.

3. The device as claimed in claim 1, wherein the gemstones are held, on the side of the mounts that faces the viewer, by the mounts and the mounts are connected to the carrier on the opposite side.

4. The device as claimed in claim 1, wherein the mounts have a raised edge by which the gemstones are held.

5. The device as claimed in claim 1, wherein the gemstones are held by the mounts by means of an adhesive.

6. The device as claimed in claim 1, wherein the mounts protrude from the carrier between 0.5 mm and 3 mm, preferably about 1 mm.

7. The device as claimed in claim 1, wherein the mounts protrude from the carrier about 1 mm.

8. The device as claimed in claim 1, wherein the mounts are adhesively bonded to the carrier.

9. The device as claimed in claim 1, wherein the mounts and the carrier are formed in one piece.

10. The device as claimed in claim 1, wherein the illumination elements are embodied as light emitting diodes or comprise light emitting diodes.

11. The device as claimed in claim 1, wherein illumination elements are arranged in a plurality of the mounts.

12. The device as claimed in claim 1, wherein light emitting diodes are arranged in a plurality of the mounts.

13. The device as claimed in claim 1, wherein a plurality of the illumination elements are arranged next to the mounts or below the end of the mounts that is remote from the viewer.

14. The device as claimed in claim 13, wherein said illumination elements are embodied as light emitting diodes.

15. The device as claimed in claim 1, wherein the gemstones comprise natural or artificial glass stones.

16. The device as claimed in claim 15, wherein the glass stones are cut.

17. The device as claimed in claim 1, wherein the surface of the carrier forms substantially a curved face and the longitudinal axes of the mounts are each arranged substantially orthogonally to this face.

18. The device as claimed in claim 17, wherein said curved face is convexly curved.

19. The device as claimed in claim 1, wherein the gemstones are arranged, at least in certain portions, in rows and columns.

20. The device as claimed in claim 1, wherein the intermediate space between two adjacent mounts corresponds roughly to the average diameter of the mounts.

21. The device as claimed in claim 1, wherein the mounts and the gemstones held thereby are arranged or can be arranged as a separate component in the device for displaying time.

22. The device as claimed in claim 1, wherein the tips or panes of the gemstones define an envelope face having a curvature.

23. The device as claimed in claim 22, wherein said curvature is convex.

24. A device for displaying time, in particular a wrist watch, comprising a plurality of gemstones and a plurality of illumination elements which are arranged on or at a carrier and via which the gemstones can be selectively illuminated and have light shone through them in order to display the time, wherein each gemstone is respectively held in its own mount protruding from the carrier.

25. The device as claimed in claim 24, wherein the mounts are embodied substantially cylindrically.

26. The device as claimed in claim 24, wherein the gemstones are held, on the side of the mounts that faces the viewer, by the mounts and the mounts are connected to the carrier on the opposite side.

27. The device as claimed in claim 24, wherein the mounts have a raised edge by which the gemstones are held.

28. The device as claimed in claim 24, wherein the gemstones are held by the mounts by means of an adhesive.

29. The device as claimed in claim 24, wherein the mounts protrude from the carrier between 0.5 mm and 3 mm, preferably about 1 mm.

30. The device as claimed in claim 24, wherein the mounts protrude from the carrier about 1 mm.

31. The device as claimed in claim 24, wherein the illumination elements are embodied as light emitting diodes or comprise light emitting diodes.

32. The device as claimed in claim 24, wherein the gemstones comprise natural or artificial glass stones.

33. The device as claimed in claim 24, wherein the surface of the carrier forms substantially a curved face and the longitudinal axes of the mounts are each arranged substantially orthogonally to this face.

34. The device as claimed in claim 24, wherein the gemstones are arranged, at least in certain portions, in rows and columns.

35. The device as claimed in claim 24, wherein the tips or panes of the gemstones define an envelope face having a curvature.

36. A method for manufacturing a device as claimed in claim 1, wherein the gemstones are fastened to the mounts and subsequently the mounts comprising the gemstones are mounted to the carrier.

37. The method as claimed in claim 36, wherein the mounts comprising the gemstones are individually mounted to the carrier.

38. The method as claimed in claim 36, wherein the mounts comprising the gemstones are jointly mounted to the carrier.
